(19) United States
(12) Patent Application Publication
(10) Pub. No.: US 2006/0071441 A1
(43) Pub. Date: Apr. 6, 2006

(54) Lower control arm kit for vehicle with four link rear suspension

(76) Inventor: William Mathis, Margate, FL (US)

Correspondence Address: MCHALE & SLAVIN, P.A., 2855 PGA BLVD, PALM BEACH GARDENS, FL, 33410, US

(21) Appl. No.: 10/959,805

(22) Filed: Oct. 6, 2004

(51) Int. Cl. B60G 21/05

(52) U.S. Cl. 280/124.128

(57) ABSTRACT

The present invention provides a suspension tuning device and kit for vehicles with four link rear suspensions. More specifically, the suspension tuning device generally comprises a pair of billet aluminum lower control arms each having a spring platform rotatably secured to a weight jacking bolt and a removable/replaceable sway bar attachment plate. Each end of the control arms include a transverse thru-bore adapted to accept a three part urethane bushing or a spherical bearing. The lower control arms are constructed to mount within a standard four link rear suspension, such as that supplied on a FORD MUSTANG, to permit quick suspension alterations throughout a predetermined range.

### FIELD OF THE INVENTION

The present invention relates to a device for quickly and easily adjusting the rear suspension of a vehicle equipped with a solid rear axle and a four link rear suspension, more particularly, the invention relates to a lower control arm that allows operator controlled adjustment of ride height, weight distribution and roll center of a vehicle to enhance vehicular performance for racing and/or high performance street applications.

### BACKGROUND OF THE INVENTION

The versatility and performance of newer muscle cars such as the FORD MUSTANG permit owners to use one vehicle for multiple purposes. Often the same vehicle used to carry groceries home from the supermarket is used for racing applications on the weekend. Owners often modify their vehicle to make it more competitive in their chosen form of racing. Because racing is only a part-time application of the vehicle, the vehicle must remain useful for its other purposes.

Rear wheel drive vehicles typically include a front suspension for wheels that also turn and a rear suspension for the drive wheels. Rear vehicle suspensions may be generally categorized as either solid axle or independent. Solid axle rear suspensions generally include a plurality of rigid links pivotally connected between the rear axle and the vehicle frame to attach and stabilize the rigid axle in fore, aft, and rotational directions. The present invention relates to solid axle rear suspensions having four links connecting the rear axle, and thus the remainder of examples will be limited thereto.

Vehicles supplied from the factory with four link rear suspensions generally include one lower and one upper control arm to limit and control the travel of each associated rear wheel. In general these suspensions have a fixed ride height controlled by a biasing means such as a coil spring, leaf spring, torsion bar, MacPherson strut or air spring. The suspensions also include a sway or anti-roll bar to help control body roll during cornering.

One of the most modified areas of a vehicle for racing applications is the suspension. The most basic and primary job of the suspension on any vehicle is to isolate the chassis from shock and vibration. The suspension accomplishes this by allowing the wheels to move with respect to the vehicle chassis in response to road conditions. In addition to isolating shock and vibration, the suspension controls the handling characteristics of the vehicle. Ideally, the suspension geometry is arranged to keep the tire tread flat and straight with respect to the road surface throughout its entire range of motion. The suspension should maintain the wheels in the proper camber attitude and position with respect to the road surface during cornering, braking and acceleration loads, and control vehicle ride height while resisting body roll, yaw and pitch angles that may create undesirable handling characteristics.

Unfortunately, dynamic loading of the suspension during hard cornering and/or acceleration, often experienced by high performance vehicles, adversely affects the rear wheel camber and alignment of stock suspensions. Factory suspensions are generally supplied with stamped low-grade steel control arms having a U-shaped cross section and include soft rubber bushings at each end for attachment to the torque box and the solid rear axle to reduce vibration and road noise within the vehicle. The torque box and rear axle each typically include outwardly extending tabs arranged to cooperate with the rubber bushings for mounting and alignment of the rear axle. The low-grade steel and the open cross section of the control arms permit uncontrolled flexing within the components. In addition, the soft bushings deflect under high loads causing uncontrolled and unpredictable changes in wheel camber and alignment. Changes in wheel camber and/or alignment can have a dramatic affect on the handling characteristics of a vehicle. Camber affects how the tires contact-patch cooperates with the road surface, and alignment affects how the vehicle turns.

Tuning a four link rear suspension can be one of the most critical aspects of getting a vehicle with a solid rear axle to handle properly for either street or racing applications. Unfortunately, within the prior art four link suspensions that are modified exclusively for racing typically are not suitable for street driving under all conditions, and stock four link suspensions typically cannot be tailored for racing or high performance applications. Street applications generally emphasize ride quality and vehicle stability over a wide range of conditions and thus utilize fixed ride height, fixed roll or sway, fixed wheel travel and fixed corner weights. Racing or high performance applications require adjustable ride heights to accommodate various types of racing tires, surfaces and conditions. Also required is the ability to alter weight bias, roll center, individual corner weights (wedge) and individual wheel travel. One of the biggest challenges for a muscle car owner has been to maximize and balance the vehicle for both street and racing applications.

Another key factor to improving a vehicle's handling for racing applications is reducing unsprung weight. Unsprung weight is the weight not carried by the springs, such as the tires, wheels, brakes and suspension components. In contrast, sprung weight is the weight supported by the springs. The vehicles body, frame, transmission, and motor are examples of sprung weight. Reducing unsprung weight allows the suspension to react faster to bumps or irregularities on the road surface; this allows the tires to stay in better contact with the road, increasing grip and controllability. The stamped low-grade steel control arms supplied by the factory require thick heavy sections to reduce the uncontrolled flexing discussed above, substantially increasing unsprung weight and thus reducing performance.

Equalizing rear tire loads is another important factor for improving the handling characteristics of a vehicle for any application. In general, maximum traction performance is significantly greater when both rear tires carry equal loads. Equalizing tire loads requires adjustability within the suspension to tune the vehicle for a specific application. For example, a vehicle driven around corners tends to unload the inside tires. Therefore, an oval track racer preferably minimizes center of gravity heights and widens the track width of the vehicle. While a drag racer is not going around any corners, he is faced with a similar problem in that the drive shaft torque tends to unload one rear tire. Rear tire loads can be equalized either statically or dynamically. The static solution is to pre-load one rear tire. The dynamic solution is to adjust roll stiffness. Roll stiffness is adjusted by altering the sway bar. Stiffer sway bars allow less body roll and softer sway bars permit increased body roll. Currently known stock and aftermarket lower control arms do not provide for these types of adjustability.

Accordingly, what is lacking in the art is a suspension tuning kit for vehicles with four link rear suspensions and solid rear axles. The suspension tuning kit should achieve objectives such as providing: quick adjustment, increased suspension rigidity, a range of adjustability, and reliable performance. The suspension tuning kit should include packaging flexibility for installation on various vehicle configurations, including retrofitting existing vehicles with minimal modification of the original suspension system. The suspension tuning kit should facilitate independent ride height, wedge and body roll adjustments. The suspension tuning kit should reduce unsprung weight. The suspension tuning kit should facilitate quick suspension changes to allow a vehicle to be driven to a racetrack, converted to a race setup, and thereafter quickly converted back to a street driving setup for the trip home.

### DESCRIPTION OF THE PRIOR ART

A number of prior art solid axle rear suspension systems exist to attach and stabilize a rigid axle of a vehicle in fore, aft, and rotational directions.

U.S. Pat. No. 4,087,116 teaches a suspension for a vehicle. A drive axle suspension system that includes a rigid drive axle and a housing therefor, an upper pair of links pivotally coupled at their front ends to the vehicle body and at their rear ends to opposed end portions of the housing, and a lower pair of links pivotally coupled at their front ends to the vehicle body and at their rear ends to opposed end portions of the housing. The angle through which either one of the upper links or one of the lower links is pivotally connected between the associated end portions of the housing and the vehicle body is made different from the angle through which either the other of the upper links or the other of the lower links is pivotally connected between the associated end portions of the housing and the vehicle body.

U.S. Pat. No. 4,453,738 teaches a four link suspension system for a monocoque vehicle body, which comprises a pair of upper control arms and a pair of lower control arms adapted to swingably support a rigid axle housing encasing an axle shaft against the body. The body has a floor panel, and a pair of side members spaced from each other in a transverse direction of the body, are provided at both sides of the panel. A cross member is disposed between both side members with a distance from the floor panel and secured at its both ends to the side members. The upper control arms are disposed inside of the lower control arms, and each forward end of the upper control arms is pivoted to said cross member.

U.S. Pat. No. 4,919,449 teaches a vehicle rear suspension includes a rucher-like mechanism providing one connection of the semi-elliptic spring, or link equivalent of the suspension linkage to the vehicle sprung mass. The mechanism incorporates pivots and spring means effective to enable rear wheel roll understeer during vehicle cornering, while also absorbing impact forces acting on a rear wheel as the wheel hits a bump.

U.S. Pat. No. 5,458,359 teaches a four-link suspension for a ground vehicle, of the type which utilizes a lower pair and an upper pair of connecting links to attach and stabilize a rigid axle of a vehicle in fore, aft, and rotational directions. The improvement to which comprises the addition of a swivel arm, having two ends, and interposed between a pair of links at one end, so that, one end of each link attaches to a corresponding end of swivel arm. The swivel arm has a center pivot axis and attached base mount, which is securely affixed to the approximate middle laterally of the rigid axle or chassis, whichever location is the most desireable to mount the swivel. When looked at from above the impression created is that of a V or U shape from the pair of links and the swivel where they connect. The general purpose of the swivel is to eliminate any bind in the suspension connecting links by permitting one link of the pair to push past, and the other link to pull away from, the swivel center axis. This motion allows the rigid axle to tilt freely from side to side in relation to the vehicle's body, through the full range of vertical suspension travel, when the vehicle is traversing uneven terrain, or leaning when rouning a curve. Plus, the swivel allows for almost infinite mounting angles and lengths of the connecting links, for frame, chassis, or body mounting location considerations, or high performance setup, tuning, and adjustment.

U.S. Pat. No. 5,803,200 teaches a suspension for a ground vehicle which connects a rigid axle to the vehicle chassis and stabilizes the rigid axle in fore, aft, and rotational directions. The suspension comprises four links and a swivel. The four links extend within a predetermined number of degrees of parallel to a longitudinal axis of the vehicle, and connect the rigid axle to the vehicle chassis. Two of the links are normally attached above, and two of the links are normally attached below the rigid axle centerline. Therewith, the swivel comprises an arm having two opposite ends and a centrally positioned pivot shaft. Each end of the arm being interposed between an end each of two of the four links thus the pivot shaft is held steadfast to the surface residing between the locations where the pair of link ends would otherwise attach. Said surface being either of the vehicle framework or of the rigid axle, whichever location is preferred. Furthermore, the improvement to the above described swivel four-link suspension comprises a method for an adjustable means which makes it relatively easy to vary the inclination of the swivel pivot shaft axis upon the surface to which the pivot shaft is held firm. Therefore, the swivel arm pivot motion angle can be realigned with the swivel attaching link pair's push-pull direction, for optimal swivel functioning, whenever a change is made to the setup angle of the swivel attaching link pair.

U.S. Pat. No. 6,354,614 teaches a link assembly for a suspension system of a motor vehicle. The link assembly includes a link having a barrel portion at each end. The barrel portion is narrower than that of previously developed links and is fitted with tapered cone bushings. The narrower links and tapered cone bushings enable a greater degree of articulation of the link without the edges of the barrel portions hitting the surfaces of the mounting brackets to which the link is attached. Each barrel portion also includes an integral ring which limits the lateral movement of each link assembly without limiting torsional movement. Each barrel portion also includes integrally formed grease passageways for enabling lubricant to be held within the barrel portions when the tapered cone bushings are assembled thereto.

U.S. Pat. No. 6,354,614 teaches a four-link suspension system. The suspension system includes a main support bracket with a plurality of holes formed therein and a plurality of links attached thereto. Each of the plurality of links has a plurality of holes formed therein for engaging a respective one of the plurality of holes formed in the main support bracket. The particular placement and combination of the holes in the main support bracket and each link, the size of each hole and slot, the shape of each link, the shape of the main support bracket, and the engagement of the links to the main support bracket permit the four-link suspension system to have hundreds of possible instant center (I/C) choices and locations.

U.S. Pat. No. 5,702,121 teaches a structure for connecting a stabilizer bar and a lower control arm to each other, the structure includes a separate connecting member, elastic members, clamping bolts and nuts. The connecting member is composed of an upper fixture, a lower fixture and a supporter, and molded into one body with plastic materials. The elastic members are inserted on the inside of the fixtures. Bolts and nuts clamp both ends of the connecting member with the stabilizer bar and the lower control arm respectively.

As disclosed, the above devices fail to teach or suggest a suspension tuning mechanism in the form of a lower control arm capable of ride height, weight bias and body roll adjustments required for high performance applications. The prior art is also deficient in teaching a suspension tuning mechanism in the form of a lower control arm capable of reducing the unsprung weight while providing the suspension rigidity and stability required by high performance and/or racing vehicle applications.

### SUMMARY OF THE INVENTION

The present invention provides a suspension tuning device and kit for vehicles with four link rear suspensions. More specifically, the suspension tuning device generally comprises a pair of billet aluminum lower control arms each having a spring platform rotatably secured to a weight jacking bolt and a removable/replaceable sway bar attachment plate. Each end of the control arms include a transverse thru-bore adapted to accept a three part urethane bushing or a spherical bearing. The lower control arms are constructed to mount within a standard four link rear suspension, such as that supplied on a FORD MUSTANG, to permit quick suspension alterations throughout a predetermined range.

The instant invention is generally provided as a kit that comprises a pair of billet aluminum lower control arms which replace the original equipment manufacturer (OEM) stamped metal lower control arms. The lower control arms are preferably constructed from billet 6061 T6 aluminum and include increased bending and torsional rigidity when compared to the OEM components. Each control arm includes a top surface, a bottom surface and a pair of side surfaces. The side surfaces are constructed to include contoured inwardly extending cavities which leave a central structural web. This construction provides superior bending and torsional rigidity while reducing the weight and thus the unsprung weight of the arms.

The urethane bushings are preferably provided as a three piece construction comprising a high durometer inner disk that controls fore and aft arm deflection, and two lower durometer outer bushings that allow for angular articulation of the lower control arms to minimize suspension bind. Spherical bearings may be substituted for the urethane bushings to further increase rigidity and stability of the assembly. Fasteners extend through either the urethane bushings or the spherical bearings to allow the arms to be attached within the OEM mounting points.

Extending through the upper and lower surfaces of each arm is a spring seat bore. The spring seat bore preferably includes internal threads to cooperate with the spring seat assembly. The spring seat assembly includes an elongated threaded jack bolt, a spring seat, and a locking nut. The spring seat includes a stepped upper surface constructed and arranged to cooperate with a coil spring and a central aperture which may include a bushing or roller bearing for rotatably securing the spring seat to the threaded member. In this manner vehicular corner weight and height adjustments may be completed without jacking up the car to unload the spring. The threaded member engages the threaded spring seat bore to provide vertical adjustment, and the locking nut engages the threaded member as well as the lower surface of the control arm to secure the spring seat assembly in a predetermined position with respect to the control arm.

The lower surface of the control arm also includes an integrally machined sway bar boss. The sway bar boss includes at least two bolt apertures for attachment of a sway bar mounting plate. In this manner various types of sway bar mounting plates may be secured to the lower surface of the control arms, or the sway bar mounting plates may be omitted to provide additional ground clearance and reduced unsprung weight to the vehicle.

The lower control arms may be installed on either one or both sides of the rear suspension of the vehicle, and each lower control arm may be independently configured and adjusted to suit a particular application.

Accordingly, it is an objective of the present invention to provide a suspension tuning kit for vehicles with a solid rear axle and a four link suspension.

An additional objective of the present invention is to provide a suspension tuning kit for vehicles with solid rear axles which allows rapid ride height and corner weight adjustment without jacking up the vehicle to unload spring compression.

It is a further objective of the present invention to provide a suspension tuning kit for vehicles with a solid rear axle and a four link suspension that significantly reduces unsprung weight.

A still further objective of the present invention is to provide a lower control arm for vehicles with a solid rear axle and four link suspension that is constructed from billet aluminum to provide additional bending and torsional rigidity to the vehicle suspension system when compared to the prior art.

Another objective of the present invention is to provide a suspension tuning kit for vehicles with a solid rear axle and a four link suspension which is simple to install and which is ideally suited for original equipment and aftermarket installations.

Yet another objective of the present invention is to provide a suspension tuning kit for vehicles with a solid rear axle and a four link suspension that is simple and reliable in operation.

Still another objective of this invention is to provide a lower control arm for vehicles with a solid rear axle and a four link rear suspension that includes a removable and replaceable sway bar mounting plate.

Still yet another objective of the instant invention is to provide a lower control arm for vehicles with a solid rear axle and a four link rear suspension wherein each end of the control arms include a transverse thru-bore adapted to accept a three part urethane bushing or a spherical bearing.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a partial perspective view illustrating the rear suspension of a vehicle equipped with a four link rear suspension;

FIG. 2 is a perspective view of one lower control arm of the instant invention;

FIG. 3 is an exploded view of one lower control arm of the instant invention;

FIG. 4 is a section view of the lower control arm taken along lines 1-1 of FIG. 3;

FIG. 5 is a section view of the lower control arm taken along lines 2-2 of FIG. 3;

FIG. 6 is a bottom perspective view of the lower control arm.

### DETAILED DESCRIPTION OF THE INVENTION

Although the invention is described in terms of a preferred specific embodiment, it will be readily apparent to those skilled in this art that various modifications, rearrangements and substitutions can be made without departing from the spirit of the invention. The scope of the invention is defined by the claims appended hereto.

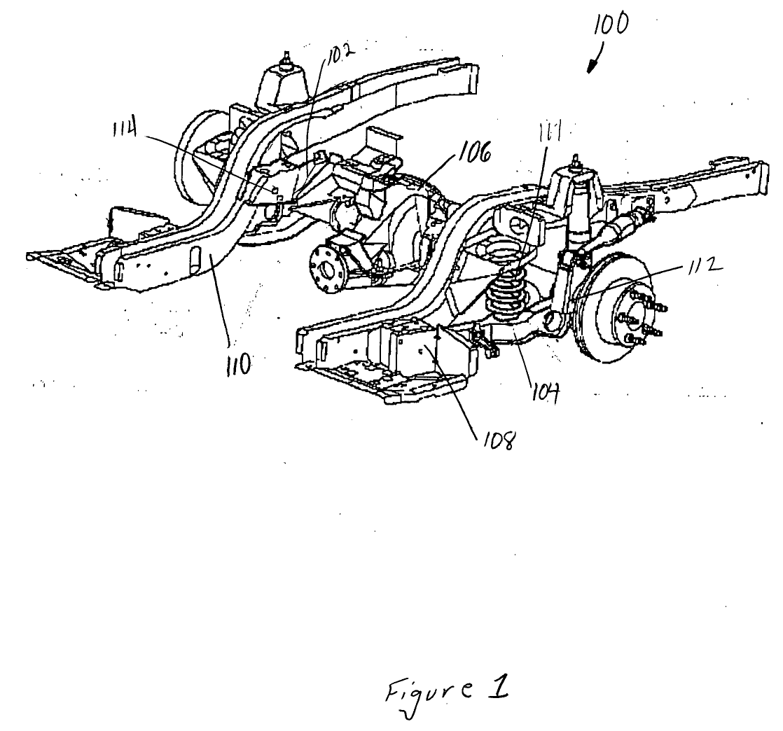

Referring to FIG. 1, there is shown a prior art four link suspension 100 for a solid rear axle 106 and surrounding structure to which the four links, e.g. two upper control arms 102 and two lower control arms 104, are attached within a motor vehicle suspension system. The lower control arms 104 are secured to an OEM torque box 108 which is in turn secured to a frame portion 110 of the vehicle at one end of the control arm and to an OEM axle bracket 112 at the opposite end of the control arm 104. The axle bracket 112 is in turn secured to a solid rear axle 106 of the vehicle. The upper control arms 102 are similarly arranged and attached at both the front and rear ends thereof, albeit above the centerline of the solid rear axle 106. The front portion of the upper control arms 102 are attached to brackets 114 secured to the frame 110, and the rear portions are attached to the solid rear axle 106. The OEM lower control arms 104 include tubular portions at opposing ends thereof. In each tubular portion is disposed a rubber, single bushing having a molded-in steel sleeve. The bushing is frequently bonded into its tubular portion. Each bushing receives a bolt therethrough which secures each lower control arm to its associated mounting bracket.

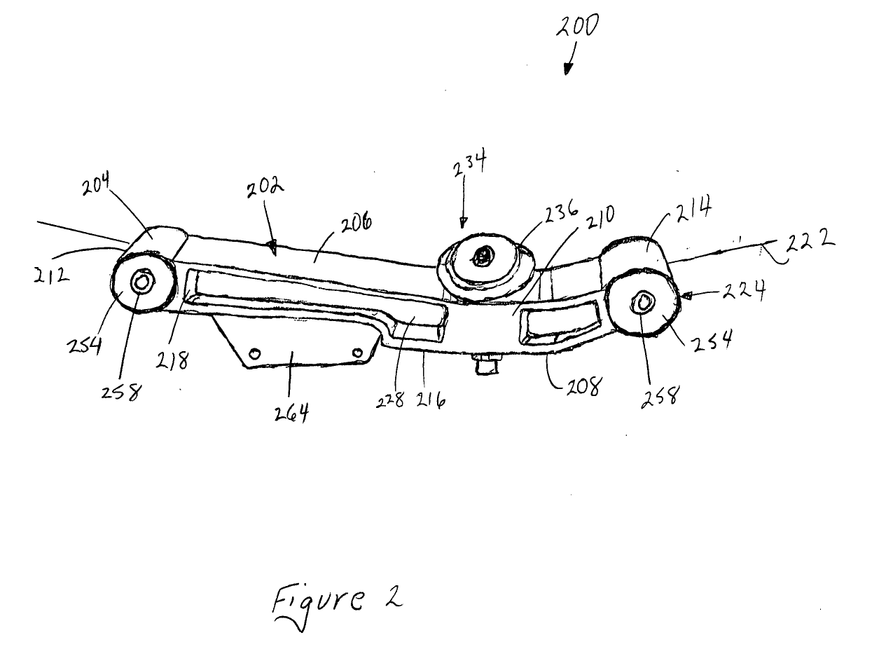

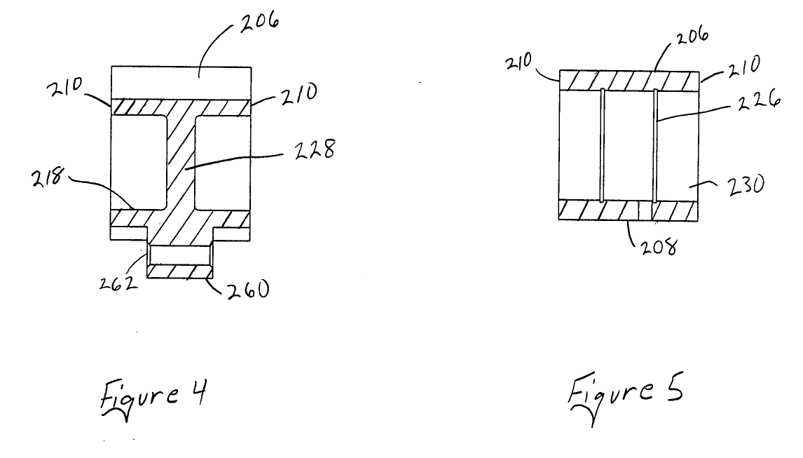

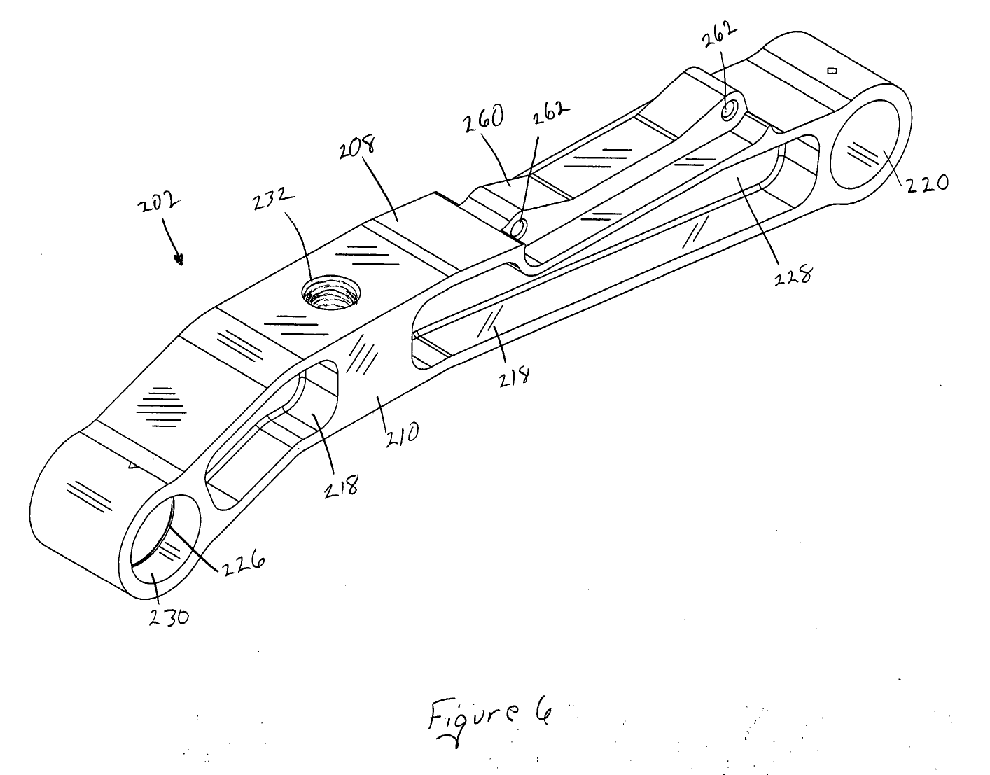

Referring to FIGS. 2 through 5, a perspective and an exploded view of one lower control arm of the instant invention is illustrated. The instant invention provides a suspension tuning kit 200 which replaces the stamped metal lower control arms 104 (FIG. 1) of the prior art. The suspension tuning kit 200 comprises at least one and preferably two, lower control arms 202. Each control arm 202 includes a front end 212 for pivotal connection to a vehicle frame or body, a rear end 214 for pivotal connection to a solid rear drive axle and a center portion 216 extending therebetween. The center portion 216 includes an outer contoured perimeter 204 defined by a top surface 206, a bottom surface 208 and two side surfaces 210. The contoured perimeter 204 allows the control arm to be moved over a broad range while assembled in close proximity to suspension and frame components without interference. The pair of side surfaces 210 are preferably constructed to include at least one and preferably two contoured cavities 218. The contoured cavities 218 extend inwardly from each side surface 210 to leave a central web 228. In this manner unsprung weight of the lower control arm 202 is reduced without significantly sacrificing rigidity or strength of the control arm.

The front end 212 includes a first bore 220 extending substantially transverse with respect to a longitudinal centerline 222. The rear end 214 includes a second bore 230 also extending substantially transverse to the longitudinal centerline 222. Both the first and the second bore are preferably constructed for securing a bushing means illustrated herein as a resilient urethane bushing member 224. The resilient member 224 preferably includes a center portion 252 and two outer portions 254. The center and outer portions having a central bore 256 constructed and arranged to receive a tubular sleeve 258, wherein said tubular sleeve is constructed and arranged to receive a bolt for securing the lower control arm to the vehicle body or the drive axle respectively. In a most preferred embodiment, the resilient center portion 252 of the bushing member has a higher durometer hardness than the outer portions 254. In this manner, the higher hardness center portion controls fore and aft movement of the control arm while the softer outer portions allow the control arm to travel throughout its entire range of motion without binding. Alternatively, each bore may include a pair of snap ring grooves 226 for retaining a spherical bearing (not shown). The spherical bearing also includes a central bore constructed and arranged to receive a bolt for securing the lower control arm to the vehicle body or the drive axle respectively. Snap rings, well known in the art, cooperate with the snap ring grooves 226 to retain the resilient or spherical bearing within a respective bore. It should also be noted that other means well known in the art may be utilized to retain the resilient urethane bushing or the spherical bearing within the first and second bores.

Still referring to FIGS. 2 through 5, the center portion 216 of each control arm 202 includes a third threaded bore 232 extending substantially orthogonal with respect to the first and second bores 220, 230. The third threaded bore 232 is constructed and arranged to accept an adjustable spring seat assembly 234. The adjustable spring seat assembly includes a spring seat 236 coupled to a threaded stem 238. The spring seat includes a top surface 240 that is preferably constructed and arranged to cooperate with a coil spring 111 (FIG. 1), a generally flat bottom surface 242, and a central aperture 244. The threaded stem 238 includes a lower threaded portion 246 constructed and arranged to threadably engage the third threaded bore 232 and an upper stem portion 248 constructed to engage the central bore 244 of the spring seat 236. In a preferred embodiment, the stem portion includes a bearing means that may include but should not be limited to polymeric self lubricating material, metal self lubricating material, ball bearings, needle bearings and suitable combinations thereof. The bearing means permits the stem portion to be rotated with respect to the spring seat without lifting the weight of the car off of the spring seat. In this manner, the rotation of the threaded stem causes the adjustable spring seat to move vertically throughout a predetermined range.

In a preferred and non-limiting embodiment, the control arms 202 are constructed of billet aluminum, and in a most preferred embodiment the control arms are constructed of 6061 T6 billet aluminum. The control arm may alternatively be made from other metals which may include, but should not be limited to steel, titanium or suitable combinations thereof. It should be appreciated that the control arm may be made sized and contoured as the space requirements, materials and wheel loads require.

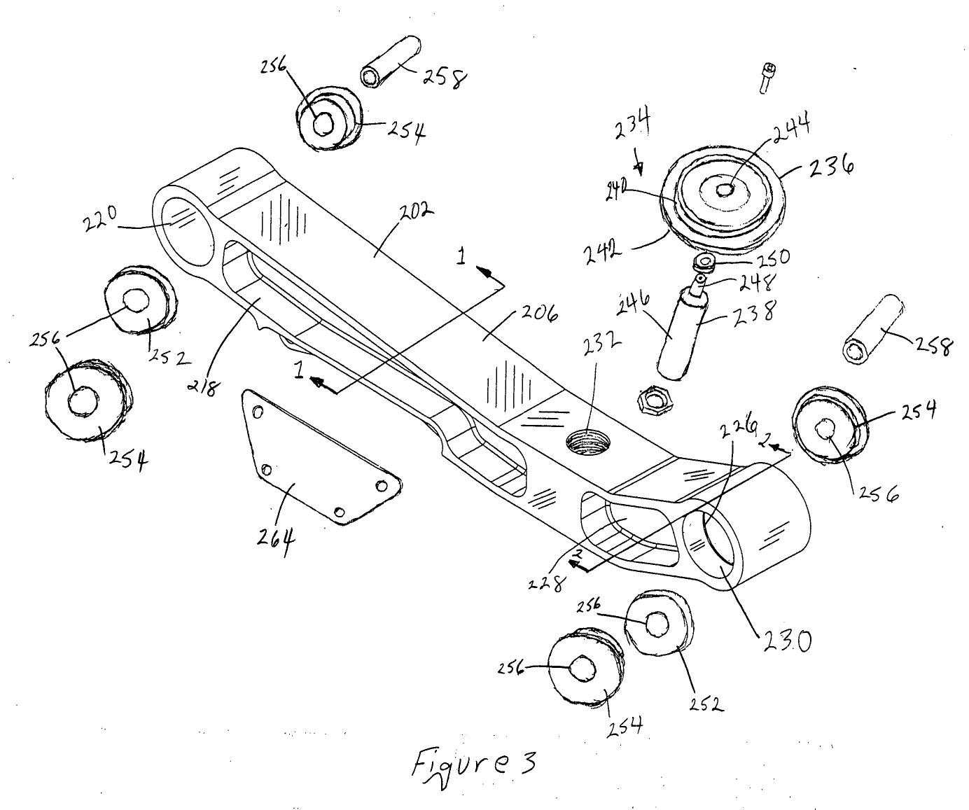

Referring to FIG. 6, the lower surface 208 of the lower control arm 202 is illustrated. The lower surface 208 includes an integrally machined boss 260. The boss 260 includes at least two apertures 262 arranged to align with and secure a sway bar attachment plate 264 (FIG. 3) thereto. A plurality of fasteners (not shown) extend through the apertures 262 and cooperate with the sway bar attachment plate to permit the sway bar attachment plate to be removable and replaceable. In this manner, sway bar attachment plates of varying constructions may be secured to the lower control arm 202 to suit a particular application. Alternatively, the sway bar attachment plate may be removed entirely to reduce unsprung weight within the vehicle.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. In a rear vehicle suspension, wherein said suspension includes a rigid drive axle, a pair of OEM upper control arms pivotally coupled at their front ends to the vehicle body and at their rear ends to opposed portions of said rigid drive axle, and a pair of OEM lower control arms pivotally coupled at their front ends to the vehicle body and at their rear ends to opposed portions of said rigid drive axle, a suspension tuning kit comprising:
at least one lower control arm for replacing at least one of said OEM lower control arms, said at least one lower control arm including a front end, a rear end, and a center portion, a longitudinal centerline extending between said front end and said rear end, said center portion including a top surface, a bottom surface and a pair of side surfaces, said front end including a first bore extending substantially transverse with respect to said longitudinal centerline, said rear end including a second bore extending substantially transverse with respect to said longitudinal centerline, said first bore and said second bore including bushing means constructed and arranged to permit articulation of said lower control arm, said center portion including a third threaded bore extending substantially orthogonal with respect to said first and said second bores through said top and said bottom surfaces, said third threaded bore constructed and arranged to accept an adjustable spring seat assembly, said adjustable spring seat assembly constructed and arranged to cooperate with a coil spring, wherein said adjustable spring seat assembly includes a spring seat coupled to a threaded stem, said spring seat having a top surface and a bottom surface, wherein said top surface is constructed and arranged to cooperate with and position said coil spring and wherein said bottom surface is secured to said threaded stem, wherein said threaded stem constructed and arranged to theadably engage said third threaded bore;
whereby rotation of said threaded stem causes said adjustable spring seat to move vertically throughout a predetermined range.

2. The suspension tuning kit as set forth in claim 1 wherein said bushing means is a resilient member, wherein said resilient member includes a central bore constructed and arranged to receive a tubular sleeve, wherein said tubular sleeve includes a central bore constructed and arranged to receive a bolt for securing said lower control arm to said vehicle body or said drive axle respectively.

3. The suspension tuning kit as set forth in claim 1 wherein said bushing means is a three piece resilient urethane member including a center portion and two outer portions, wherein said inner portion has a higher durometer hardness than said outer portions, wherein said resilient member includes a central bore constructed and arranged to receive a tubular sleeve, wherein said tubular sleeve includes a central bore constructed and arranged to receive a bolt for securing said lower control arm to said vehicle body or said drive axle respectively.

4. The suspension tuning kit as set forth in claim 1 wherein said bushing means is a spherical bearing, wherein said spherical bearing includes a central bore constructed and arranged to receive a bolt for securing said lower control arm to said vehicle body or said drive axle respectively.

5. The suspension tuning kit as set forth in claim 1 wherein said adjustable spring seat assembly includes a spring seat rotatably coupled to a threaded stem, said spring seat having a top surface, a bottom surface and a centrally located bore, wherein said top surface is constructed and arranged to cooperate with and position said coil spring and wherein said centrally located bore is constructed and arranged to cooperate with said threaded stem, wherein said threaded stem is constructed and arranged to threadably engage said third threaded bore, whereby rotation of said threaded stem may be accomplished without rotation of said spring seat;
whereby rotation of said threaded stem causes said adjustable spring seat to move vertically throughout a predetermined range.

6. The suspension tuning kit as set forth in claim 5 wherein said spring seat centrally located bore includes a self lubricating bushing secured therein.

7. The suspension tuning kit as set forth in claim 5 wherein said spring seat centrally located bore includes a bearing secured therein.

8. The suspension tuning kit as set forth in claim 1 wherein said pair of side surfaces each include at least one contoured cavity therein, wherein said at least one contoured cavity is constructed and arranged to reduce the unsprung weight of said lower control arm.

9. The suspension tuning kit as set forth in claim 1 wherein said pair of side surfaces each include two contoured cavities therein, wherein said two contoured cavities are constructed and arranged to reduce the unsprung weight of said lower control arm.

10. The suspension tuning kit as set forth in claim 1 wherein said at least one lower control arm is constructed of aluminum.

11. The suspension tuning kit as set forth in claim 1 wherein said bottom surface includes an integrally machined boss, said boss including at least two through bores for attachment of a sway bar attachment plate thereto, whereby said sway bar attachment plate is removable and replaceable.

12. In a four link vehicle suspension, a pair of lower control arms each including a front end for pivotal connection to a vehicle body, a rear end for pivotal connection to a solid rear drive axle, a center portion extending between said front end and said rear end and a longitudinal centerline extending between said front end and said rear end, said center portion including a top surface, a bottom surface and a pair of side surfaces, said front end including a first bore extending substantially transverse with respect to said longitudinal centerline, said rear end including a second bore extending substantially transverse with respect to said longitudinal centerline, each said upper surface including a spring and each said lower surface including an integrally machined boss, said boss including at least two through bores for attachment of a sway bar attachment plate thereto, whereby said sway bar attachment plate is removable and replaceable.

13. The lower control arms of claim 12 wherein said center portion of each said control arm includes a third threaded bore extending substantially orthogonal with respect to said first and said second bores through said top and said bottom surfaces, said third threaded bore constructed and arranged to accept an adjustable spring seat assembly, said adjustable spring seat assembly constructed and arranged to cooperate with a coil spring, wherein said adjustable spring seat assembly includes a spring seat coupled to a threaded stem, said spring seat having a top surface and a bottom surface, wherein said top surface is constructed and arranged to cooperate with and position said coil spring and wherein said bottom surface is secured to said threaded stem, wherein said threaded stem constructed and arranged to threadably engage said third threaded bore;
whereby rotation of said threaded stem causes said adjustable spring seat to move vertically throughout a predetermined range.

14. The suspension tuning kit as set forth in claim 12 wherein said bushing means is a resilient member, wherein said resilient member includes a central bore constructed and arranged to receive a tubular sleeve, wherein said tubular sleeve includes a central bore constructed and arranged to receive a bolt for securing said lower control arm to said vehicle body or said drive axle respectively.

15. The suspension tuning kit as set forth in claim 12 wherein said bushing means is a three piece resilient member including a center portion and two outer portions, wherein said inner portion has a higher durometer hardness than said outer portions, wherein said resilient member includes a central bore constructed and arranged to receive a tubular sleeve, wherein said tubular sleeve includes a central bore constructed and arranged to receive a bolt for securing said lower control arm to said vehicle body or said drive axle respectively.

16. The suspension tuning kit as set forth in claim 12 wherein said bushing means is a spherical bearing, wherein said spherical bearing includes a central bore constructed and arranged to receive a bolt for securing said lower control arm to said vehicle body or said drive axle respectively.

17. The suspension tuning kit as set forth in claim 12 wherein said adjustable spring seat assembly includes a spring seat rotatably coupled to a threaded stem, said spring seat having a top surface, a bottom surface and a centrally located bore, wherein said top surface is constructed and arranged to cooperate with and position said coil spring and wherein said centrally located bore is constructed and arranged to cooperate with said threaded stem, wherein said threaded stem is constructed and arranged to threadably engage said third threaded bore, whereby rotation of said threaded stem may be accomplished without rotation of said spring seat;
whereby rotation of said threaded stem causes said adjustable spring seat to move vertically throughout a predetermined range.

18. The suspension tuning kit as set forth in claim 17 wherein said spring seat centrally located bore includes a self lubricating bushing secured therein.

19. The suspension tuning kit as set forth in claim 17 wherein said spring seat centrally located bore includes a bearing secured therein.

20. The suspension tuning kit as set forth in claim 12 wherein said pair of side surfaces each include at least one contoured cavity therein, wherein said at least one contoured cavity is constructed and arranged to reduce the unsprung weight of said lower control arm.

21. The suspension tuning kit as set forth in claim 12 wherein said pair of side surfaces each include two contoured cavities therein, wherein said two contoured cavities are constructed and arranged to reduce the unsprung weight of said lower control arm.
